(19) United States
(12) Patent Application Publication
(10) Pub. No.: US 2011/0087384 A1
(43) Pub. Date: Apr. 14, 2011

(54) SYSTEM AND METHOD FOR CONSERVING ELECTRICAL CAPACITY

(75) Inventor: Sanjay Bose, West Edison, NJ (US)

(73) Assignee: CONSOLIDATED EDISON COMPANY OF NEW YORK, INC., New York, NY (US)

(21) Appl. No.: 12/576,692

(22) Filed: Oct. 9, 2009

(51) Int. Cl. G05D 11/00

(52) U.S. Cl. 700/295

(57) ABSTRACT

A system and method of operating a complex system, such as an electrical transmission and distribution system is provided. The system includes a plurality of local assets that are used to form a contingency asset pool in the event that an operational issue is detected. The contingency assets may include dispatchable loads and on-site electrical power generation including diesel and natural gas fueled generators, and renewable power energy sources. The contingency asset pool conserves the capacity of the system on a local level and allows the system operator to maintain a high level of reliability while minimizing some of the costs associated purchasing, installing and maintaining redundant equipment.

### BACKGROUND OF THE INVENTION

The subject matter disclosed herein relates to a system and method for operating an electrical grid, and in particular to a system and method of operating an electrical grid while conserving local or distributed capacity to provide for contingencies events.

Large complex systems often incorporate layers of redundancy. This redundancy allows the system to maintain operations even in the event of the loss or unavailability of one or more resources. For example, an electrical power transmission and distribution system 20, such as that illustrated in FIG. 1, is arranged with two levels of redundancy in each portion of the system such that electrical power can still be delivered even if two resources are lost. The resources may include electrical power generation plants 22, transmission lines 24, substations 26, and the like. A control center 30 is coupled to communicate with each of the resources to control the flow of electrical power. This communication may be through computerized control systems, or involve manual intervention by personnel associated with the resource. It should be appreciated that this redundancy is designed into each portion of the electrical transmission and distribution system 20, including but not limited to, power generation 22, high voltage transmission lines 24, substations 26 and low voltage distribution 28.

Systems such as the electrical transmission and distribution system 20 often do not operate at a continuous level. Electrical demand, for example, varies over the course of the day, such as the demand curve 32 illustrated in FIG. 2, with the lowest demand 34 being during the early morning hours. As people wake up, the demand for electrical power grows until reaching a peak demand period 36. The peak demand is typically between 11 AM and 5 PM. It should be appreciated that the demand curve 32 will also vary during the course of the year with the highest levels of demand coming during either January (peak heating period) or July/August (peak cooling period).

Since it is desirable to have high reliability during these cold and warm periods, the electrical transmission and distribution system 20 is designed to handle these short duration, but high level seasonal peaks. While a utility may have some flexibility with certain resources, such as the operation or purchase of electrical power from a power generation plant 22 for example, other resources, such as capital equipment including transformers, high voltage transmission lines and the like, need to be purchased, installed and operational well in advance of the seasonal peaks.

Having two levels of redundancy provides a high level of reliability in the delivery of electrical power to end customer even though the system includes thousands of pieces of equipment spread over hundreds or even thousands of miles. This reliability, however, does come with a price. The redundant equipment needs to be purchased, installed, and maintained to cover a small period of time during peak seasons. Thus, the electrical transmission and distribution system 20 operates with an overcapacity of resources for most of the year, and even most of the day during seasonal peaks.

Therefore, while existing electrical transmission and distribution systems are suitable for their intended purposes, there remains a need for improvements in providing high levels of reliability while decreasing overcapacity during non-peak periods.

### BRIEF DESCRIPTION OF THE INVENTION

According to one aspect of the invention, a system for operating an electrical system is provided. The system includes a plurality of sensors coupled to the electrical system. A plurality of contingency assets is coupled to said electrical system. A controller is operably coupled to the plurality of sensors and the plurality of contingency assets. The controller includes at least one processor responsive to executable computer instructions when executed on the at least one processor for activating at least one of the plurality of contingency assets to reduce electrical demand from the at least one of the plurality of contingency assets on the electrical system in response to a first signal from at least one of the plurality of sensors indicating an N−1 contingency condition has occurred.

According to another aspect of the invention, a method for operating an electrical system is provided. The method includes the steps of defining a contingency asset pool from a plurality of electrical generation and load assets. The contingency asset pool is coupled to a controller, the controller including at least one processor responsive to executable instructions comprising monitoring the electrical system with the controller. When an N−1 contingency condition is detected with the controller, at least one the plurality of electrical generation and load assets is activated from the contingency asset pool.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustration of a prior art electrical transmission and distribution system;

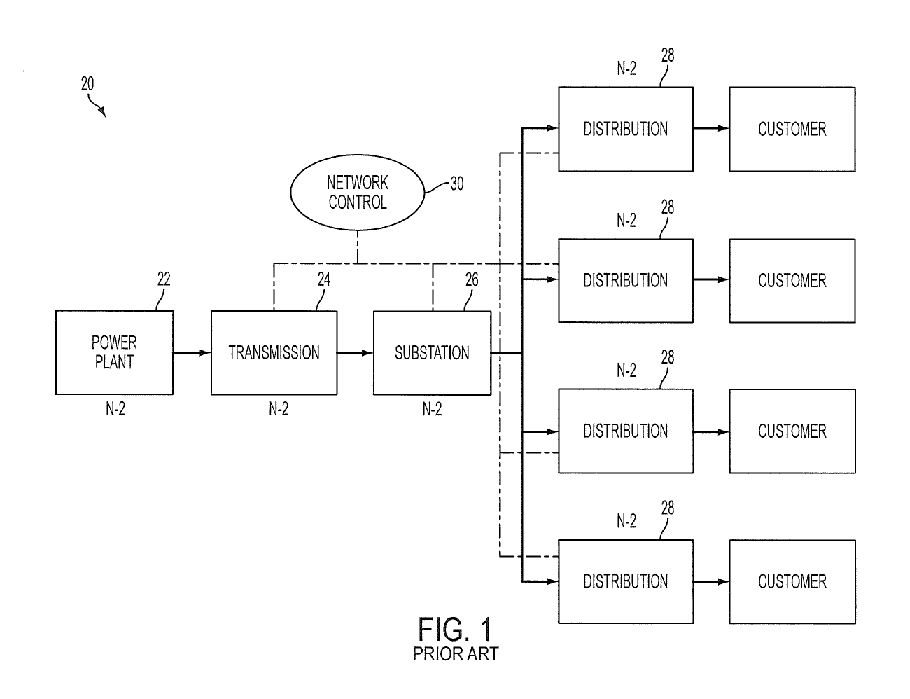

FIG. 2 is a graphical illustration of an exemplary demand curve for an electrical distribution system;

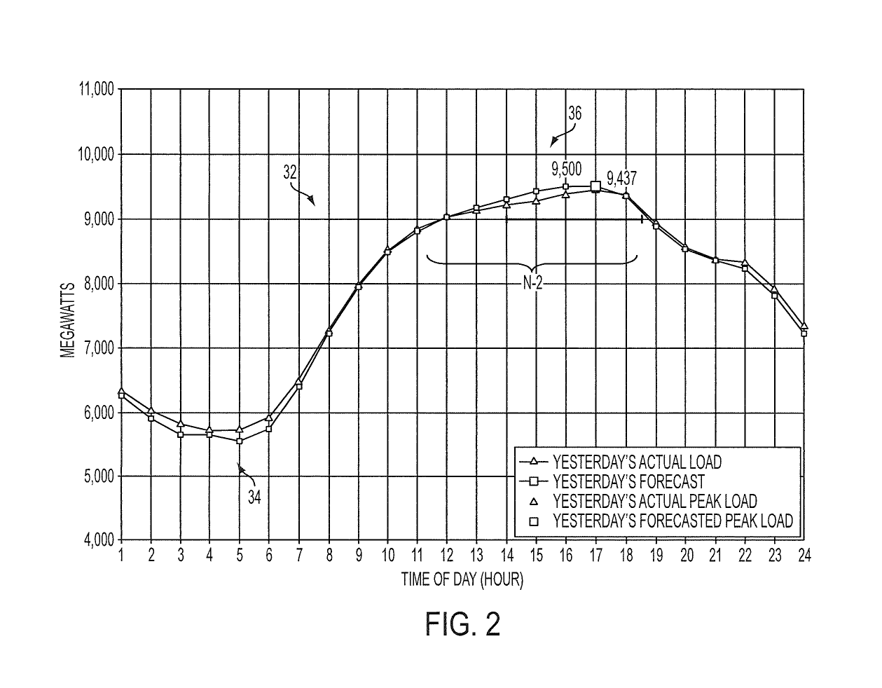

FIG. 3 is a block diagram illustration of an electrical transmission and distribution system in a first mode of operation in accordance with an embodiment;

FIG. 4 is a block diagram illustration of the electrical transmission and distribution system of FIG. 3 in a second mode of operation;

FIG. 5 is a block diagram illustration of the electrical transmission and distribution system of FIG. 3 in a third mode of operation; and,

FIG. 6 is a flow diagram illustration of a method of operating the electrical transmission and distribution system of FIG. 3.

The detailed description explains embodiments of the invention, together with advantages and features, by way of example with reference to the drawings.

### DETAILED DESCRIPTION OF THE INVENTION

Traditionally electrical transmission and distribution systems 20 were are arranged to operate with what is sometimes referred to as “N−2” contingency. As used herein, the phase “N−2 contingency” means that the system may operate with the loss of two resources. These resources include, but are not limited to electrical generation facilities, high voltage transmission lines, substation equipment, circuit breakers, feeders, and transformers, for example. A typical substation may be designed to have peak capacity for operation on two transformers, use three of the transformers during normal operation and maintain a fourth transformer as a spare. In this way, if any two of the transformers were not available, such as due to preventive maintenance or equipment malfunction, the substation would still be able to operate during peak demand periods. Another example is an overloaded distribution or transmission electrical line. If an electrical line fails in one segment of the network, the remaining segments of the network would need to have sufficient capacity to carry the electrical power to the end customer.

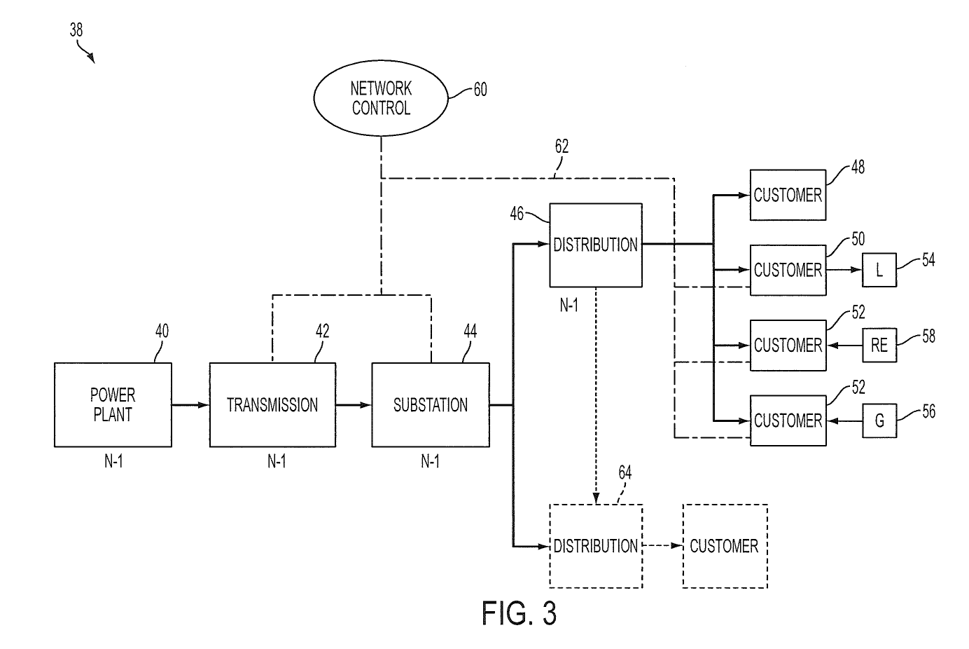

One embodiment of an electrical transmission and distribution system 38 having sufficient capacity to manage a N−1 contingency (described in detail below) in the power generation 40, transmission 42, substation 44 and distribution 46 sections is illustrated in FIG. 3. Each of the segments 40, 42, 44, 46 may include a number of different pieces of equipment. For example, substation 44 may also include equipment such as fuses, surge protection, controls, meters, capacitors, load tap changers and voltage regulators.

The electrical transmission and distribution system 38 is arranged to deliver electrical power from the electrical power generation facilities 40 to end customers 48, 50, 52. Some of the end customers 50 have a dispatchable load 54. As will be discussed in detail below, a dispatchable load 54 is an electrical load that the customers may shutoff or disable to decrease their electrical demand on the electrical transmission and distribution system 38. Other end customers 52 have on-site electrical generation systems 56, 58 that may offset part or all of the electrical demand on the electrical transmission and distribution system 38 from the end customer 52. The on-site electrical generation systems may include diesel or natural gas fueled generators 56, or a renewable energy power source 58.

It should be appreciated that while the embodiments herein are in reference to customers 48, 50, 52 coupled to distribution segment 46, and substation 44, this is for exemplary and clarity purposes and the claimed invention should not be so limited. The electrical transmission and distribution system 38 may have a number of distribution segments 64 coupled to substation 44 and may have many additional substations and transmission segments (not shown).

The electrical transmission and distribution system 38 also includes a central control center 60. The electrical transmission and distribution system 38 operation is controlled by the control center 60. Control center 60 includes suitable electronic devices or controllers capable of accepting data and instructions, executing the instructions to process the data, and presenting the results. In one embodiment, the control center 60 includes electronic devices for monitoring and engines for simulating and presenting contingency scenarios to the operators of electrical transmission and distribution system 38. These simulation engines may be in response to data measured by sensors coupled to the electrical transmission and distribution system 38, external data such as weather reports for example, or historical information. It should be appreciated that while embodiments herein refer to a control center 60, the electrical transmission and distribution system 38 may have multiple control centers, or a hierarchy of control centers each responsible for a segment of the electrical transmission and distribution system 38 or a particular geographic area.

The control center 60 is coupled by a transmission medium 62 to equipment and sensors in the transmission 42, substation 44, distribution sections 46 and to the end customers 48, 50, 52. The transmission medium 62 may be any type of known network including, but not limited to, a wide area network (WAN), a public switched telephone network (PSTN) a local area network (LAN), a global network (e.g. Internet), a virtual private network (VPN), and an intranet. The transmission medium 62 may be implemented using a wireless network or any kind of physical network implementation or combination of implementations known in the art. Transmission medium 62 includes, but is not limited to, twisted pair wiring, coaxial cable, fiber optic cable, powerline cable, wireless, radio, infrared signal transmission systems or a hybrid or combination thereof.

During normal operation, the electrical transmission and distribution system 38 operates as illustrated in FIG. 3 with electrical power flowing from the power generators 40 to the end customers 48, 50, 52. For customers with on-site power generation, such as diesel or natural gas fueled generator 56 or renewable energy source 58, the customer 52 may use the electrical power to offset or eliminate the demand for electrical power from the distribution segment 46. In this first mode of operation, each of the segments 40, 42, 44, 46 of the electrical transmission and distribution system 38 are operated an N−1 contingency, meaning that they could continue to operate with the failure of a single resource.

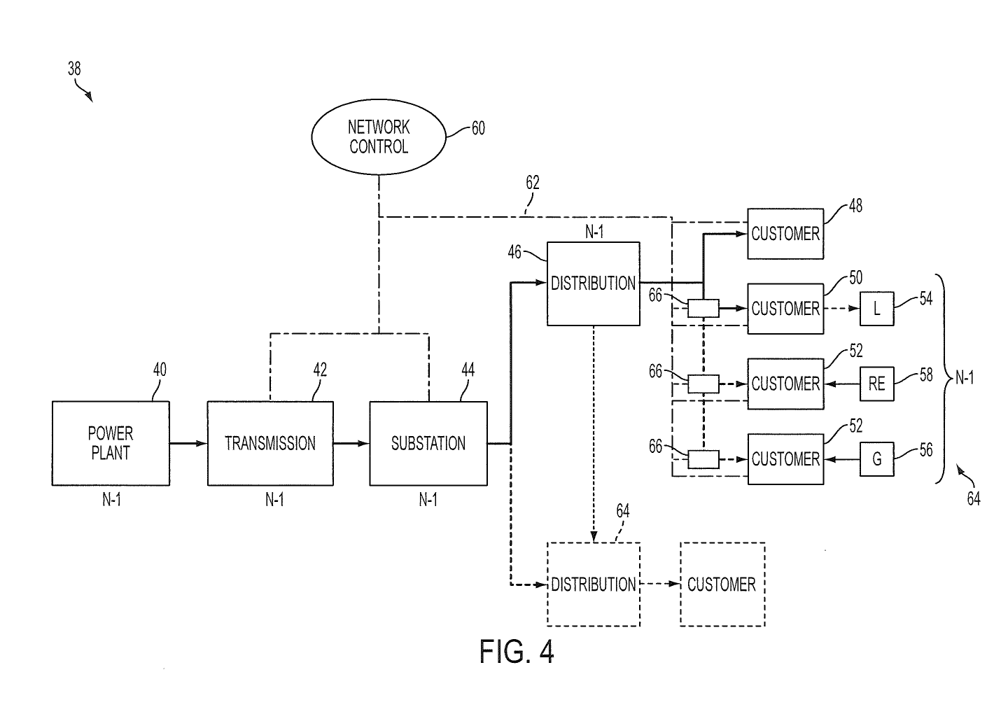

Referring now to FIG. 4, a contingency asset pool 64 is defined that represents an additional N−1 of contingency capacity in the event that an issue arises in the electrical transmission and distribution system 38. As will be discussed in more detail below, the contingency asset pool 64 may be formed as part of contingency program where the end customer operators are provided with an incentive, such as lower tariff rates or rebates for example, to participate. In the embodiment of FIG. 4, the electrical transmission and distribution system 38 includes switching equipment, such as sectionalizing switches 66. The sectionalizing switch 66 is coupled to receive commands and transmit data via the transmission medium 62 to the control center 60. The sectionalizing switch 66 includes features to allow the control center 60 to remotely open and close the sectionalizing switch 66. It should be appreciated that depending on the configuration of the distribution segment 46, the opening of one or more the sectionalizing switches 66 may segregate or island portions of the distribution segment 46.

In the embodiment of FIG. 4, the control center 60 detected a contingency event, such as a failed or overloaded electrical line in distribution segment 46, or the loss of electrical generation capacity feeding distribution segment 46 for example. Since the distribution segment 46 is arranged with N−1 contingency capacity, the loss of an electrical line allows the continued operation of the electrical transmission and distribution system 38 and the delivery of electrical power to end customers 48, 50, 52. However, further issues in distribution segment 46 may result in loss of power or degradation of service. To provide an additional level of contingency capacity, the control center 60 transmits a signal via transmission medium 62 to contingency asset pool 64 and sectionalizing switches 66.

It should be appreciated that while the embodiments herein describe the control center 60 detecting an event, this also includes scenarios wherein the control center 60 anticipates an issue, such as due to the result of an output from the simulation engine for example. In such an instance, the activation of the contingency asset pool 64 is a pre-emptive process by the control center 60 to mitigate or abate the anticipated problem.

The activation of the contingency asset pool 64 causes the end customers 52 to rely on their own on-site generation 56, 58 and the sectionalizing switches 66 associated with these end customers 52 open, eliminating the demand from these customers 52 on the distribution segment 46. The activation of contingency asset pool 64 may also result in the curtailing of loads, such as dispatchable load 54 for example, in end customer 50. It should be appreciated that disconnection of end customers 52 and the curtailment of loads in end customer 50 lowers the electrical demand on distribution segment 46. In one embodiment, the contingency asset pool 64 is sized to provide an N−1 contingency capacity, such that after the activation of contingency asset pool 64, the distribution segment 46 is returned to an N−1 level of contingency capacity. Thus, the electrical transmission and distribution system 38 retains an N−2 system contingency capacity even though the distribution segment 46 is arranged with equipment to provide an N−1 contingency capacity. This provides advantages in lower costs associated with purchasing, installing and maintaining additional contingency equipment in the distribution segment 46.

In another embodiment, multiple contingency asset pools 64 are provided, including contingency asset pools 64 in other portions of the electrical transmission and distribution system 38, such as distribution segment 64 for example. These additional contingency asset pools 64 may formed into either a collective pool or in a tiered arrangement to provide contingency capacity in the event an issue arises in a higher level of system, such as in transmission segment 42 or substation 44 for example. By combining the lower level contingency asset pools 64, issues arising in the power generation 40, transmission 42, or substation 44 segments may be offset providing the electrical transmission and distribution system 38 with an N−2 level of contingency capacity. Once the issue in electrical transmission and distribution system 38 has been resolved or repaired, the control center 60 deactivates contingency asset pool 64 and closes sectionalizing switches 66 and allowing electrical power to flow from the electrical transmission and distribution system 38 to the end customers in distribution segment 64.

In other embodiments, the individual assets in contingency asset pools 64, such as dispatchable load 54 or renewable energy source 58 for example, may be assigned a priority ranking. The control center 60 may use these priority rankings to create virtual contingency asset pools containing assets from different portions of the electrical transmission and distribution system 38. This provides advantages in allowing the control center 60 the flexibility to provide different responses based on the issue that arises in the electrical transmission and distribution system 38.

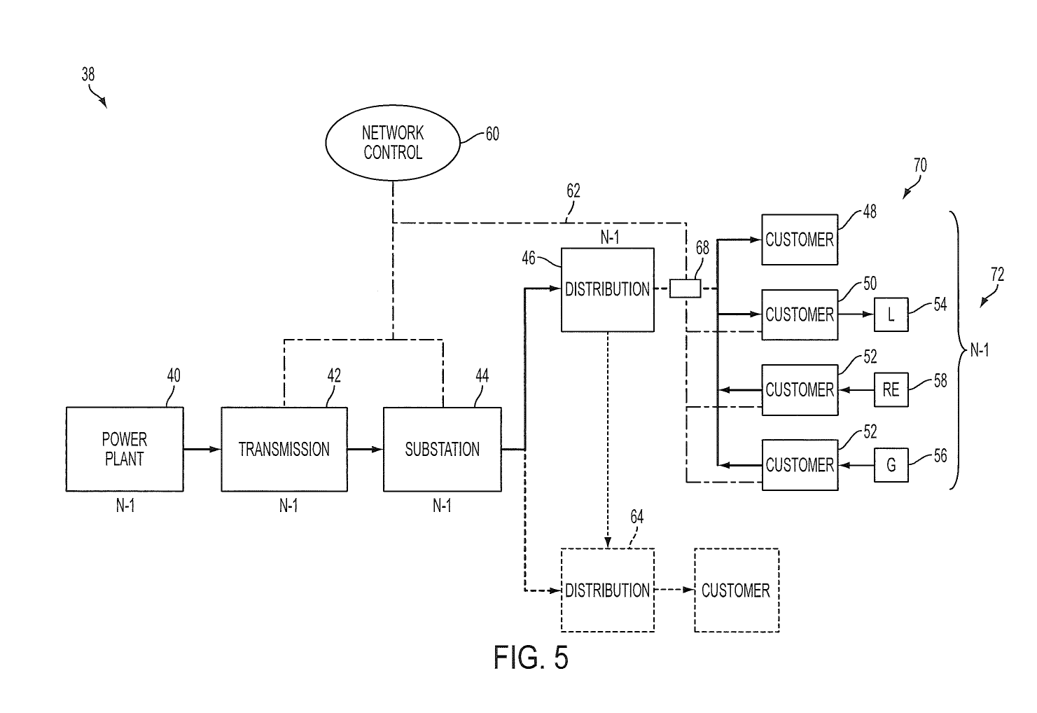

Referring now to FIG. 5, the electrical transmission and distribution system 38 is illustrated in a third mode of operation. In this embodiment, the electrical transmission and distribution system 38 includes a switching device, such as a sectionalizing switch 68, is arranged in the distribution segment 46 to allow the isolation or islanding of a portion 70 of the distribution segment 46. The switch 68 includes means for being remotely opened and closed in response to a signal from control center 60. When opened, the sectionalizing switch 68 isolates at least a portion of the distribution segment 46. In one embodiment, the sectionalizing switch 68 segregates the entire distribution segment 46 from the substation 44. It should be appreciated that in distribution segments 46 arranged in a loop-type configuration, additional switches or control devices may be actuated to prevent the flow of electrical power to the portion 70 from other portions of electrical transmission and distribution system 38.

The embodiment of FIG. 5 further includes a contingency asset pool 72 that is defined by all of the electrical consuming and generation assets in the segregable portion 70. In response to the control center 60 detecting or anticipating an issue in the electrical transmission and distribution system 38, the control center 60 opens the sectionalizing switch 68 and activates the contingency asset pool 72. The activation of contingency asset pool 72 results in electrical power from the local or distributed generation systems 56, 58 into the portion 70. In the exemplary embodiment, the sequence of opening the sectionalizing switch 68 and activation of contingency asset pool 72 is a break-before-make relationship to prevent the flow of electrical power from the portion 70 to the substation 44. Thus, the electrical power for the end customers 48, 50, 52 is provided by the diesel or natural gas fueled generator 56 and renewable energy sources 58 rather than the power generation facilities 40. In one embodiment, the size or number of end customers that comprise portion 70 will be sized based on the energy production capacity of the available distributed generation systems 56, 58.

It should be appreciated that the activation of contingency asset pool 72 eliminates the electrical demand 34 from the electrical transmission and distribution system 38. In the exemplary embodiment, the contingency asset pool 72 is sized to offset an N−1 contingency scenario, such as a loss of a feeder or a transformer in substation 44, the loss of electrical power generation, the loss of a high voltage transmission line, or an over-loaded transmission line for example. Once the issue in electrical transmission and distribution system 38 has been resolved or repaired, the control center 60 deactivates contingency asset pool 72 and closes sectionalizing switch 68 to allow electrical power to flow from the electrical transmission and distribution system 38 to the end customers in the contingency asset pool.

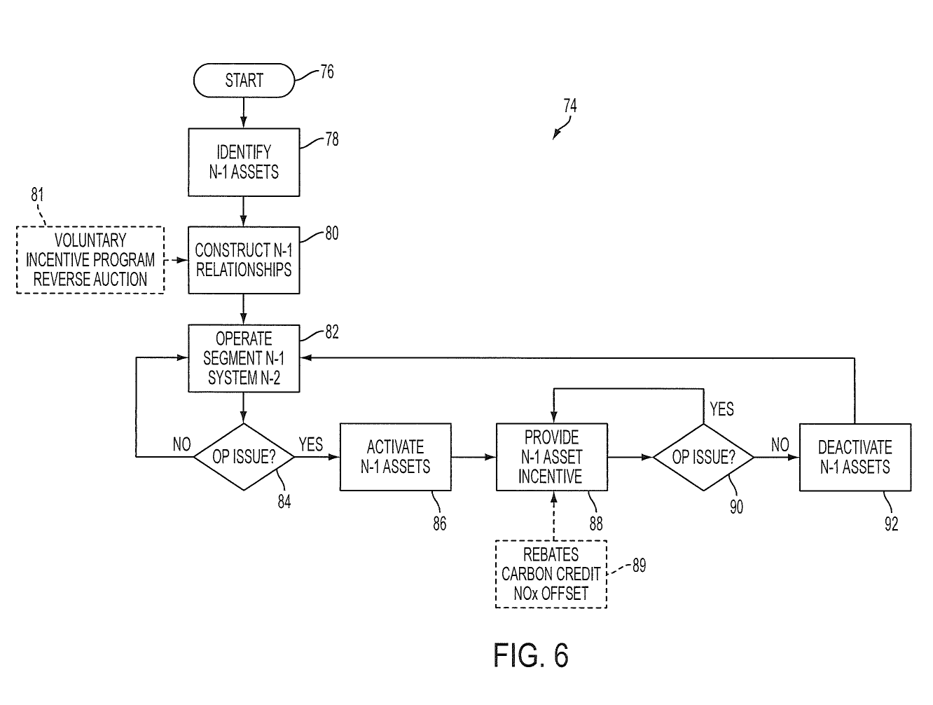

Turning now to FIG. 6, a method 74 of operating the electrical transmission and distribution system 38 is illustrated. The method 74 starts in block 76 and proceeds to block 78 where sufficient assets to form a contingency asset pool with a sufficient level of capacity to provide for an N−1 contingency is provided. With the assets identified, the method 74 proceeds to block 80 where the relationships 81 are formed with the assets forming the contingency asset pool. The relationship 81 between the asset owner and the utility may be formed using a number of mechanisms. The relationship 81 may be voluntary, where the asset owner chooses to participate without any compensation. The relationship 81 may be based on an incentive program offered by the utility or other entity, such as the government for example, where the asset owner receives some tangible benefit 89 for their participation. The benefits 89 may include, but are not limited to, direct financial payments, tax relief, rebates, lower electrical tariff rates, transfer of carbon credits or nitrous oxide offsets for example.

The relationship 81 between the asset owner and the utility may also be contractual. In one embodiment, the utility uses a reverse auctioning process where asset owners bid to participate in the contingency asset pool. The reverse auction process may be held on a periodic basis, such as daily, weekly, monthly, quarterly or annually for example. In one embodiment, the reverse auction process may be held at different defined time periods where relationships with different assets are formed for varying periods of time. In another embodiment, the contingency asset pool includes different classes of assets. Some of the classes may be available to the utility at all times, for example, while others may be available during a particular event, such as when an Independent System Operator (ISO) issues an alert or a warning for example.

With the relationships 81 for the contingency asset pool formed, the method 74 proceeds to block 82 where the electrical transmission and distribution system 38 is operated in the first or “normal” mode. When operating in this mode, the electrical transmission and distribution system 38 delivers electrical power to the end customers, and the contingency asset pool is not activated. In one embodiment, when the electrical transmission and distribution system 38 is operating in the first mode, one or more of the contingency assets may also be activated. The method 74 then proceeds to query block 84 where it is determined if there is an operational issue, such as an overloaded or malfunctioning power line, transformer or feeder for example. If the query block returns a negative, meaning there are no issues, the method 74 loops back to block 82.

If the query block 84 returns a positive, meaning that an issue has been detected or is anticipated, the method 74 proceeds to block 86 where sufficient assets to form and N−1 level of contingency capacity are activated. In one embodiment, the entire contingency asset pool is activated. In other embodiments, where the control center 60 has flexibility in the selection of assets, the control center 60 may form a virtual pool of contingency assets that are selected from a larger group. In one embodiment the virtual pool of contingency assets is selected based on the particular operation issue that is being addressed, with the selected assets forming sufficient capacity to create an N−1 contingency capacity based on the particular event. In another embodiment, the virtual pool of contingency assets are selected based on a priority ranking.

With the contingency asset pool activated, the utility provides the agreed upon incentive 89 to the participating asset operators in block 88. As discussed above, these incentives 89 may include direct financial payments, tax relief, rebates, reduced electrical tariff rates, issuance of carbon credits or nitrous oxide offsets for example. The method 74 then proceeds to query block 90 where it is determined if the operational issue continues to exist. If query block 90 returns a positive, the method 74 loops back to block 86. If query block 90 returns a negative, meaning that the operational issue has been abated, the method 74 proceeds to block 92 where the contingency asset pool is deactivated. The method 74 then loops back to block 82 where the electrical transmission and distribution system 38 is operated in the first mode.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for operating an electrical system comprising:
a plurality of sensors coupled to said electrical system;
a plurality of contingency assets coupled to said electrical system;
a controller operably coupled to said plurality of sensors and said plurality of contingency assets, said controller including at least one processor responsive to executable computer instructions when executed on said at least one processor for activating at least one of said plurality of contingency assets to reduce electrical demand from said at least one of said plurality of contingency assets on said electrical system in response to a first signal from at least one of said plurality of sensors indicating an N−1 contingency condition has occurred.

2. The system of claim 1 wherein said plurality of contingency assets provides at least a N−1 level of contingency capacity for said electrical system.

3. The system of claim 2 wherein said N−1 contingency condition is a loss of electrical generation capacity.

4. The system of claim 2 wherein said N−1 contingency condition is an over-loaded transmission line.

5. The system of claim 2 wherein said N−1 contingency condition is an equipment malfunction in a substation.

6. The system of claim 2 wherein at least one of said plurality of contingency assets includes a distributed generation system.

7. The system of claim 6 wherein said distributed generation system includes a renewable energy power source.

8. The system of claim 2 wherein at least one of said plurality of contingency assets is a dispatchable load.

9. The system of claim 2 wherein said controller is further responsive to a second signal from one of said plurality of sensors to deactivate at least one of said plurality of contingency assets to decrease electrical demand from said at least one of said plurality of contingency assets on said electrical system.

10. A method for operating an electrical system comprising:
defining a contingency asset pool from a plurality of electrical generation and load assets;
coupling said contingency asset pool to a controller, said controller including at least one processor responsive to executable instructions comprising:
monitoring said electrical system with said controller;
detecting an N−1 contingency condition with said controller; and,
activating at least one said plurality of electrical generation and load assets from said contingency asset pool with said controller in response to detecting said N−1 contingency condition.

11. The method of claim 10 further comprising:
defining an N−1 contingency program; and,
providing an incentive to operators of said plurality of electrical generation and load assets to participate in said N−1 contingency program.

12. The method of claim 11 wherein said incentive includes a reduced electrical tariff.

13. The method of claim 11 wherein said incentive includes the transfer of carbon credits.

14. The method of claim 11 wherein said incentive includes the transfer of nitrous oxide offsets.

15. The method of claim 11 wherein said incentive program includes a reverse auction wherein said operators define different time periods for participating in said program.

16. The method of claim 11 further comprising the step of deactivating said at least one said plurality of electrical generation and load assets from said contingency asset pool with said controller in response to said N−1 contingency condition being mitigated.

17. The method of claim 16 wherein said plurality of electrical generation and load assets in said contingency asset pool are coupled to a segregable portion of said electrical system.

18. The method of claim 17 further comprising the step of segregating said segregable portion in response to activating said at least one said plurality of electrical generation and load assets from said contingency asset pool.

19. The method of claim 18 wherein said contingency asset pool includes at least one distributed generation system coupled to removably apply electrical power to said segregable portion.
